(19) United States
(12) Patent Application Publication
(10) Pub. No.: US 2017/0236270 A1
(43) Pub. Date: Aug. 17, 2017

(54) Video Parts Inspection System

(71) Applicant: Mectron Engineering Company, Inc., Saline, MI (US)

(72) Inventors: Mark Hanna, Saline, MI (US); Thomas Sande, Manitou Beach, MI (US); Joe Deacons, Manchester, MI (US); Peter Gerow, Alpena, MI (US)

(21) Appl. No.: 15/503,260

(22) PCT Filed: Aug. 12, 2015
(86) PCT No.: PCT/US2015/044851

§ 371 Date: Feb. 10, 2017

Related U.S. Application Data
(60) Provisional application No. 62/036,314, filed on Aug. 12, 2014.

(51) Int. Cl. G06T 7/00; F42B 35/00; H04N 5/225; G01N 21/88; G01N 21/952

(52) U.S. Cl. CPC G06T 7/0006; G01N 21/8806; G01N 21/952; G01N 21/8851; H04N 5/2256; F42B 35/00; G01N 2201/062; G06T 2207/30164

(57) ABSTRACT

A parts inspection system for automated video inspection for quality control processes. The inspection system is particularly adapted for rotationally symmetrical workpieces including small arms ammunition cartridges. The system provides a first array of light sources oriented radially around the workpiece path presenting zones of illumination on the workpiece at discrete radial positions. A second illuminator is in the form of linear arrays of light emitting elements oriented along linear arrays. A camera oriented to observe images of light provided by the first and second arrays records video images of the workpieces for use in resolving criteria of acceptable and unacceptable parts. An escapement mechanism moves acceptable and rejected parts into different parts streams.

### FIELD OF THE INVENTION

This invention relates to a video parts inspection system for quality control applications and particularly to such a system adapted for the inspection of rotationally symmetrical parts such as small arms ammunition and other workpieces.

### BACKGROUND

In serial production of mass-produced components, quality control systems are often used to assure high-quality final products. For example, in the manufacturing of small arms ammunition such as types for handguns and rifles, it is desired to implement an automated inspection system which can identify defective parts. For example, ammunition cases typically made of brass or other metals can have defects such as nicks, gouges, voids, and discoloration. Numerous other types of rotationally symmetric workpieces such as shafts and pins pose similar inspection requirements. One approach toward providing quality control is the use of human inspectors which observe parts as they move through an assembly line stream. In addition to the cost for implementing such a system, reliability of such inspection is a concern. Numerous approaches toward automating the inspection system have been implemented. Such systems typically rely upon so-called machine vision systems in which the parts are illuminated in some manner and reflected or transmitted light images are evaluated by video cameras or linear detector arrays. Although such systems have been found to operate generally satisfactorily, they are frequently unable to resolve the full range of defects found in such components, limit throughput rate, can be costly to purchase and operate, and give rise to their own significant maintenance requirements. Accordingly there is a need to provide improved systems for such applications.

### SUMMARY

In accordance with the present invention an inspection system is provided using arrays of light sources such as LEDs arranged in a radial configuration around a part test section. The light sources are arranged to essentially form stripes of light reflecting from the workpiece. Surface disruptions in the reflected stripes reveal defects. A conveyor system is used to traverse and rotate the parts through the inspection area to enable full coverage of the inspection process.

### BRIEF DESCRIPTIONS OF THE DRAWINGS

FIG. 1 is a top view of the inspection system in accordance with the present invention;

FIG. 2 is a left isometric view of the inspection system;

FIG. 3A is a right isometric view of the inspection system;

FIG. 3B is an enlarged cutaway view from FIG. 3A showing the case illuminator:

FIG. 4 is a side view of the inspection system;

FIG. 5 is a detailed isometric view of portions of the system;

FIG. 6A is an isometric view illustrating gate operation of a defective cartridge;

FIG. 6B is a partial plan view of operation of the gate;

FIG. 7 is an illustration of gate operation for defective and non-defective cartridges;

FIG. 8 is an end view of the escapement mechanism;

FIG. 9 is a cross-section through the inspection system showing illumination of a workpiece; and

FIG. 10 is an illustration of specular reflection lines from a defective workpiece during inspection.

### DETAILED DESCRIPTION

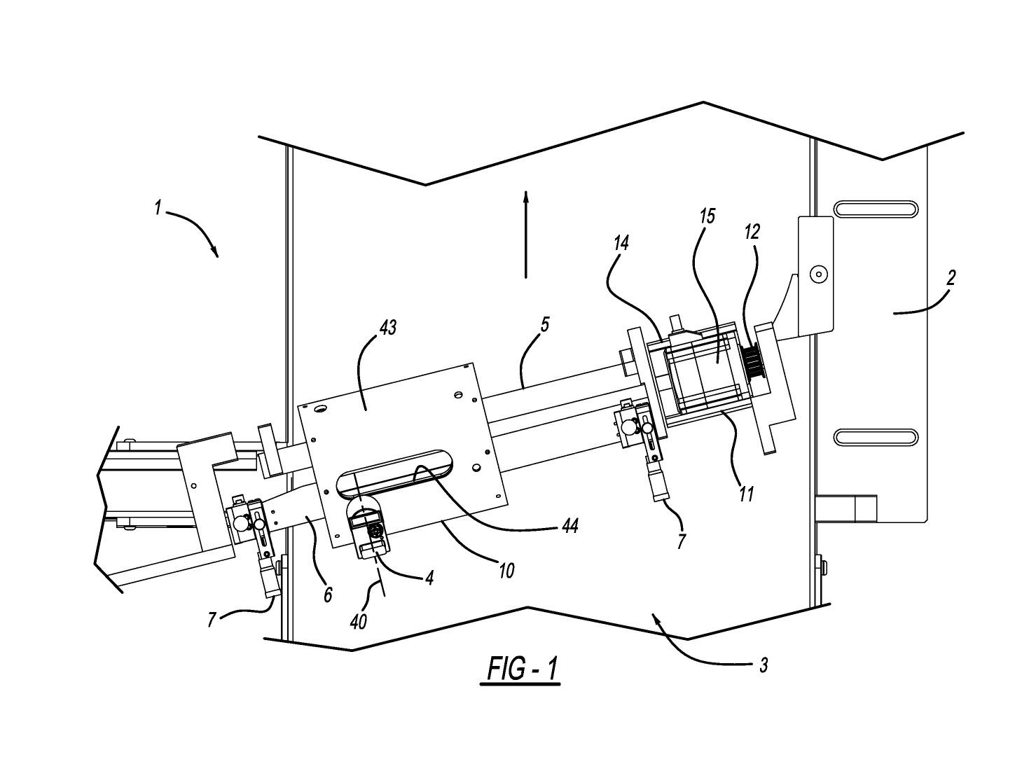

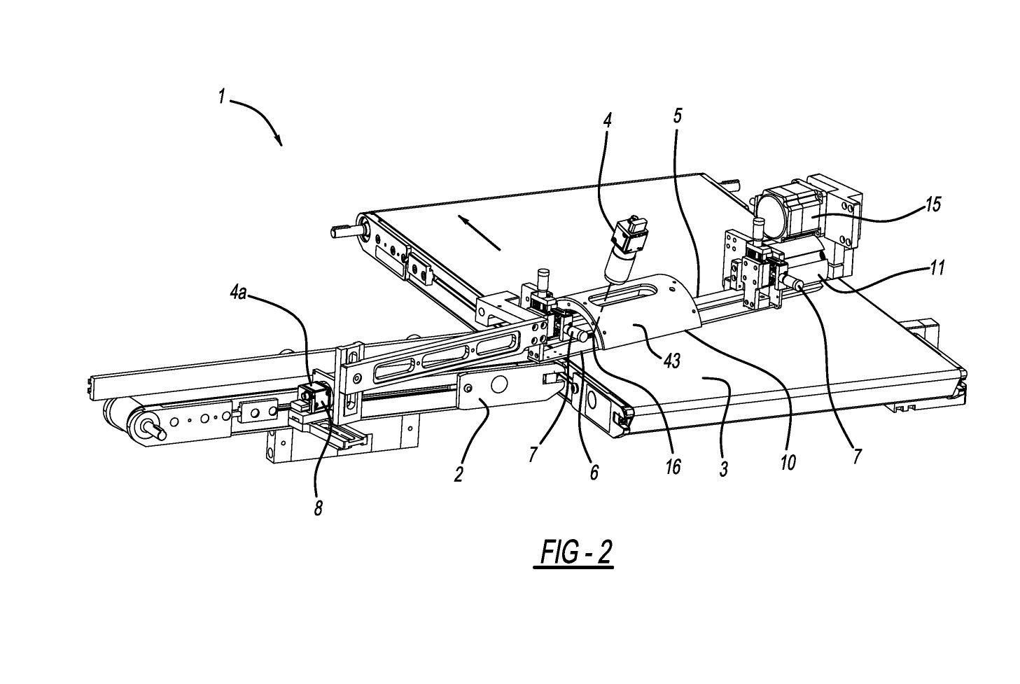

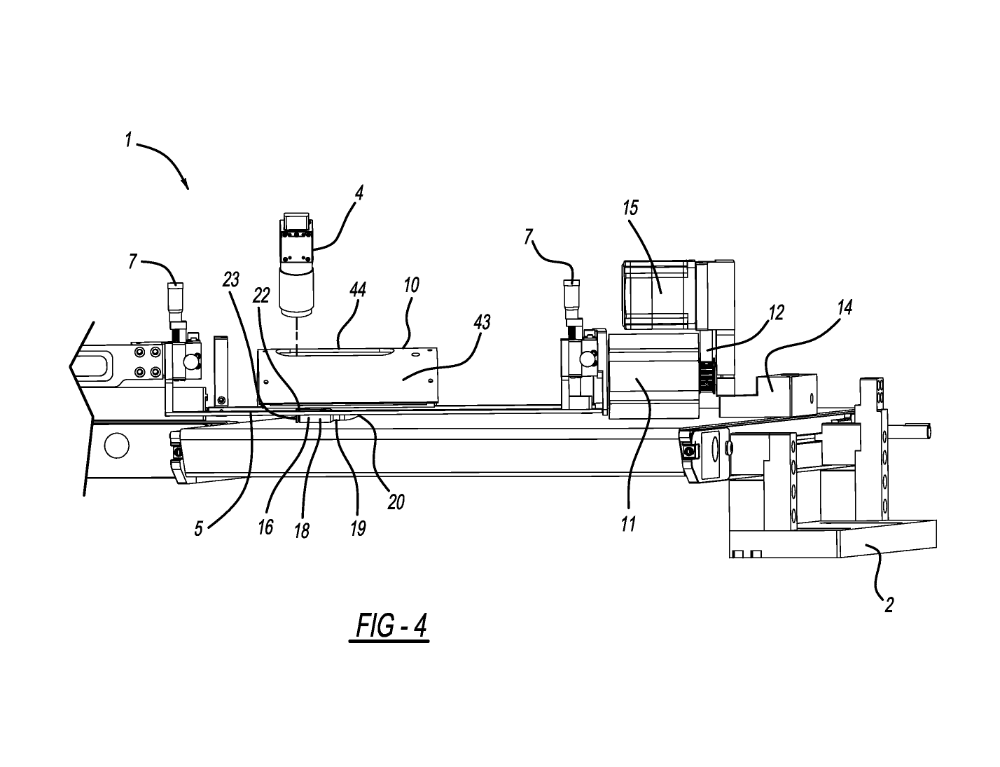

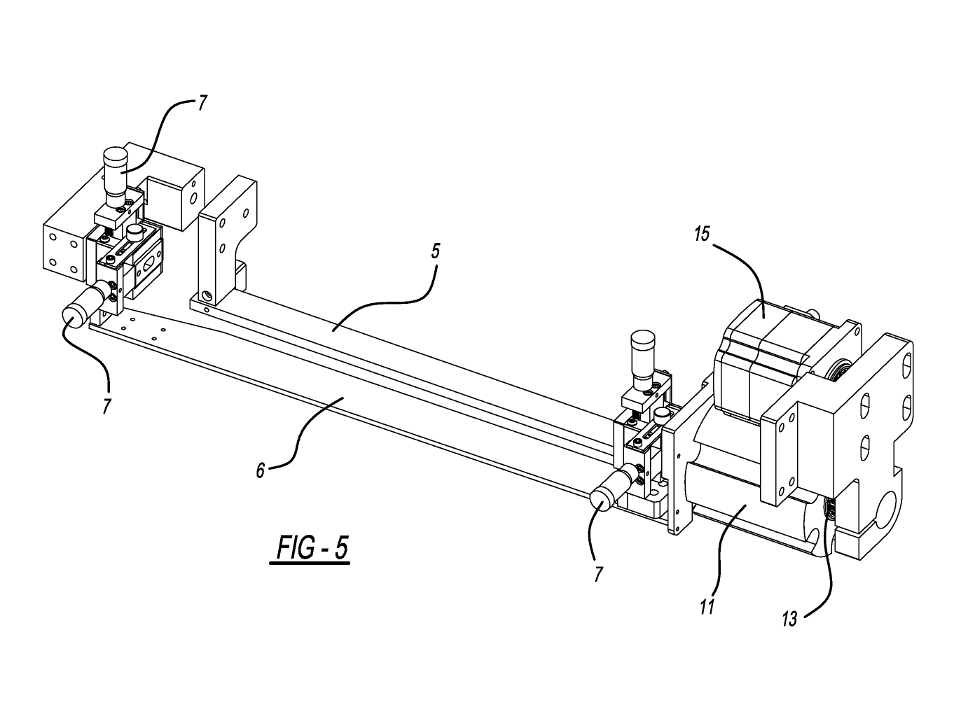

With particular reference to FIG. 1 through 4, a parts inspection system in accordance with the present invention is illustrated which is generally designated by reference number 1. As illustrated, the inspection system 1 is used in one described application for the inspection of ammunition cartridges 16. In this description workpieces 16 may alternatively be referred to as a cartridge although, as previously mentioned, other types of workpieces may also be used with the system in accordance with this invention. Preferably such alternative workpieces for inspection are rotationally symmetrical elongated parts which also may be threaded, splined, or fluted.

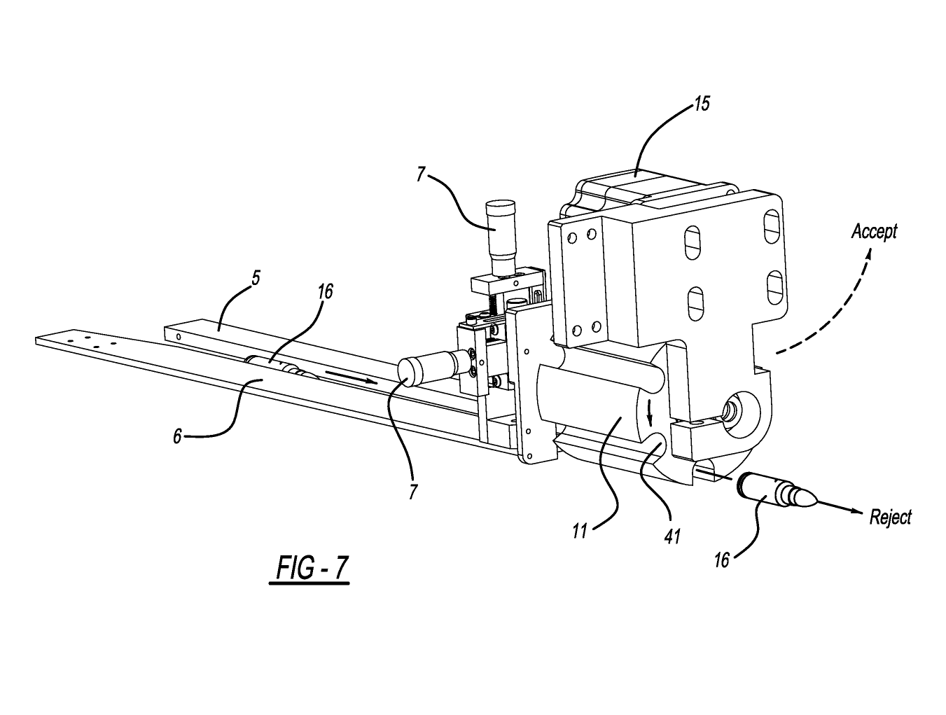

Cartridges 16 are moved through an inspection area of system 1 utilizing conveyor 3 in the form of a continuous belt which moves in the direction of the arrows in FIGS. 1-3 at a diagonal direction from the longitudinal axis of inspection system 1 (axis of the linear movement of the workpieces). Conveyor 3 moves continuously during operation of the device. Components of system 1 are supported by frame 2. Cartridge 16 is trapped between stop bar 5 and cartridge guide rail 6 and these elements are separated to allow the cartridge to travel along their length. The combined effect of the motion of conveyor 3 and the restraint provided by stop bar 5 causes cartridges 16 which are introduced at the left-hand end of the system (near one edge of conveyor belt 3) as illustrated in FIG. 1 to move from the entrance end toward escapement fence 14 (near an opposite edge of conveyor belt 3) and is simultaneously rotated as it moves linearly. The spacing between stop bar 5 and cartridge guide rail 6 is adjustable by a pair of guide rail adjusters 7 which enable precise variation in the spacing as well as the horizontal and vertical positioning of these elements. The figures illustrate cartridge 16 moving along cartridge stop bar 5 and guide rail 6, with particular reference to FIG. 7.

Cartridge 16 as illustrated is a conventional small arms rifle cartridge of a so-called “bottleneck” (i.e. necked down shell case) configuration. Cartridge 16 forms an elongated body 18 with a reduced diameter neck 19 and a protruding bullet 20. At the opposite end, cartridge 16 forms case head 21 with extractor groove 22. Case head 21 forms a head stamp end 23 having a central cavity for the installation of primer 24.

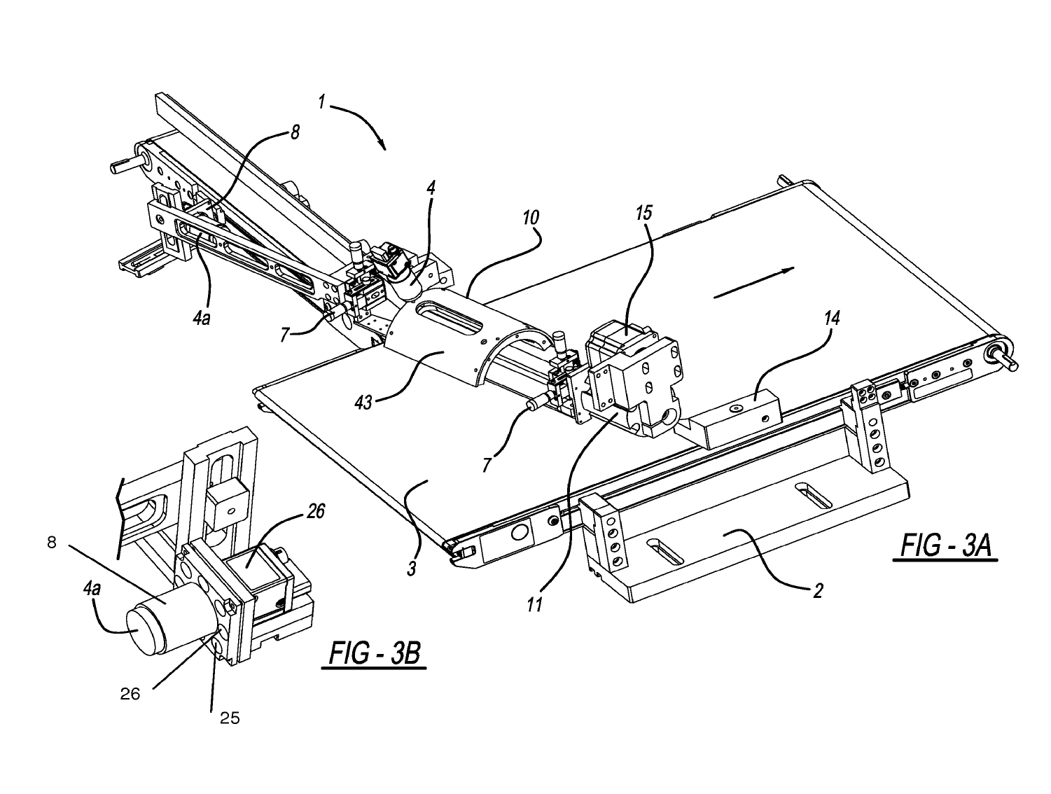

Parts inspection system 1 uses two or more different illumination sources provided for illuminating cartridge 16 in a manner to provide a full range of inspection capabilities. Primer illuminator 8 is an annular array of individual LEDs 25 oriented toward cartridge head stamp 23 as the cartridge 16 moves along the inspection axis. Primer illuminator 8 is best shown with reference to FIG. 3B is in the form of an array 26 of LEDs 25 around an aperture through which camera 4a is oriented. LEDs 25 are mounted to a board which surrounds camera 4a. Primer illuminator 8 includes LEDs oriented toward cartridge head stamp 23. A video camera 4a is oriented to collect an image of head stamp 23. These inspection components enable inspection of case defects such as a missing primer 24. As shown the primer illuminator 8 is oriented to illuminate and record images of the head stamp end of cartridge 16 as it begins its transit toward conveyor 3. A separate parts handling conveyor 3a is provided to transit the parts passed primer illuminator 8, and toward conveyor 3.

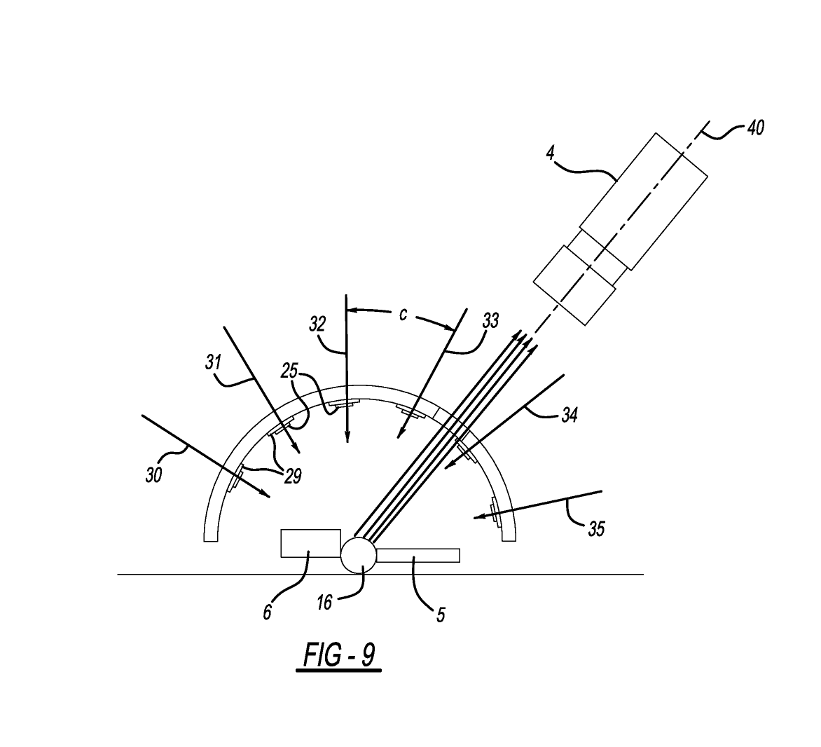

An additional series of illuminators is provided to enable evaluation of cartridge body 18, neck 19, and bullet 20. Illuminator 10 is formed by linear arrays 29 of LEDs 25 oriented as illustrated. In a representative embodiment, each linear array 29 is formed by fifteen LED elements 25. Linear arrays 29 are formed along a cylindrical surface of shell 43 oriented parallel to the longitudinal axis of the workpiece path. The linear arrays 29 form a radial separation angle “c” of 28° and a representative example which is shown in FIG. 9.

Video camera 4 is oriented as shown in the figures and observes the lines of laser light projecting onto cartridge 16 by array 29 through window 44 of shell 43. This inspection methodology is best described with reference to FIGS. 9 and 10. Linear arrays 29 of illuminator 10 cooperate to present lines of light at various angular positions with respect to the longitudinal axis of cartridge 16. FIG. 9 illustrates six lines of light 30, 31, 32, 33, 34, and 35 directed onto cartridge 16. The video image shown in FIG. 9 shows the use of the lines of light forming images of stripes 36, 37, 38, and 39. As illustrated, these stripes are interrupted in the presence of a defect shown in the figure as a nick or dent clearly observable as deviations of each of the stripes 37-39. Illuminator 10 provides illumination of the stripes on the cylindrical portions of cartridge 16 including body 18 and neck 19. Shoulder 42 forms a conical surface and shoulder/bullet illuminator 10 produces stripes 36-39 on this portion of the cartridge 16. As shown in FIG. 9, camera 4 observes images of stripes 36-39 of the cartridge 16.

As best illustrated in FIG. 1 the optical axis 40 of camera 4 is oriented to align with a radial plane of cartridge 16 as it traverses the inspection area. Other types of defects of cartridge 16 are also observable in this manner including discolorations which interrupt the specular reflection of cartridge 16. In addition to the defects mentioned previously, tears, punctures, holes, and other imperfections of the surface of cartridge 16 are readily detected.

Images from camera 4 are processed through a processing unit or computer having digital image processing software which enables the detection of defects mentioned previously.

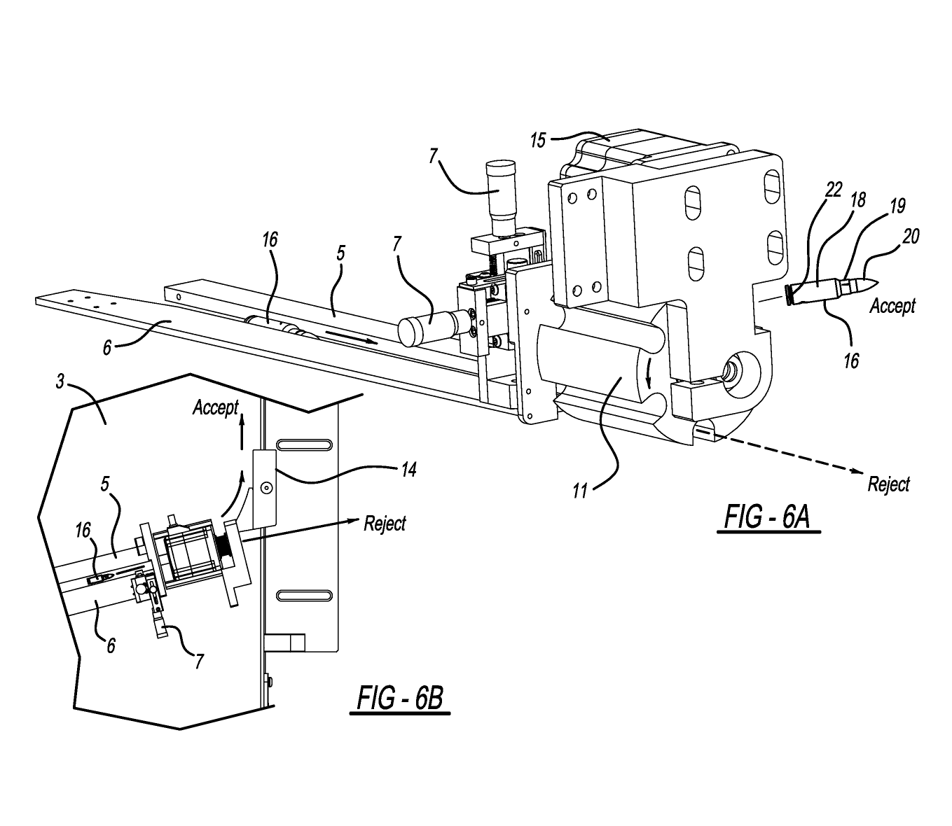

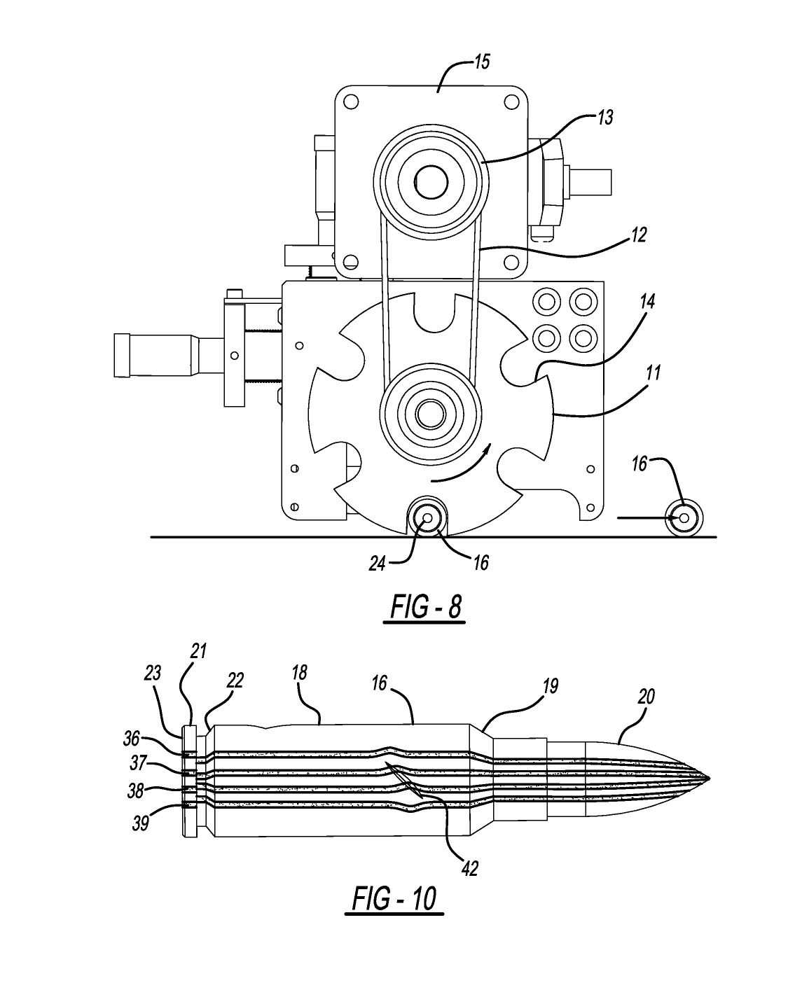

Escapement/rotary gate 11 is used to change the discharge flow paths of cartridges 16 between those meeting inspection criteria and as those that do not. Stepper motor 15 operates escapement fence 14 through timing belt 12 and timing belt pulleys 13. FIGS. 6A and 6B best illustrate operation of escapement/rotary gate 11. Those figures illustrate that slots 41 are aligned to cause rejected cartridges 16 to move through the escapement device. For cartridges 16 meeting inspection criteria, escapement 11 is operated to displace cartridges into contact with escapement fence 14 and into the “Accept” parts stream. If a cartridge 16 is deemed to have acceptable quality, the escapement 11 will rotate counterclockwise as illustrated in FIG. 8 while the cartridge is contained between the ends of the escapement slot 41 (see particularly FIGS. 6A, 6B, 7 and 8). This guides the cartridge 16 in a direction of motion of the conveyor and off the reject-parts track. The cartridge 16 leaves the escapement 11, and is pulled against the escapement by the motion of the conveyor (see FIG. 6B). The cartridge 16 has been held against the fence 14 by the body of the escapement after contacting the fence, the cartridge 16 is pulled forward by the motion of the conveyor, where it enters and Accept parts bin (see FIG. 9). The escapement 11 only completes a partial rotation during this operation, until its next slot 41 is aligned with the reject-parts track. For a rejected part, escapement 11 does not rotate and cartridge 16 is moved to by motion of conveyor 3 in the direction shown in FIGS. 6A and 6B, along the “Reject” parts stream into a suitable rejected part bin.

When a workpiece such as cartridge 16 enters the field of view of camera 4, it begins capturing images at a high frame rate. The frame rate is limited by the image resolution, which must be high enough to resolve defects that must be detected. The part must remain within the field of view of camera 4 long enough to capture images of all sides of the part (i.e. at least one full revolution). The resulting image series is filtered, corrected, and aggregated together, and used to generate several statistical models of the part. These different models reflect different types of image features.

During initial setup, a collection of pre-inspected acceptable parts are fed through the system 1. This set of parts must include samples of any manufacturing defects which are deemed acceptable. The resulting models from these acceptable parts are used to generate a “master” model, which reflects the unique aspects of an acceptable part. During normal operation, incoming parts are compared to this master model, and any parts which exceed a user-specified margin of error are directed to a reject-parts bin.

While the above description constitutes the preferred embodiment of the present invention, it will be appreciated that the invention is susceptible to modification, variation and change without departing from the proper scope and fair meaning of the accompanying claims.

1. A parts inspection system for a rotationally symmetrical elongated workpiece comprising,
a conveyor causing the workpiece to undergo linear motion and simultaneous rotational motion along a workpiece path,
a first plurality of light sources presenting sources of light illuminating the workpiece at a plurality of discrete radial orientations with respect to the central axis of the workpiece path as the workpiece undergoes the linear and rotational motion, and
a video camera oriented to detect an image of the reflections of light from the plurality of light sources from the workpiece.

2. The parts inspection system of claim 1 further comprising the conveyor in the form of an endless belt moving along a conveyor path and a stop bar oriented above the conveyor belt and oriented at an angle to the conveyor path whereby the workpiece introduced at near one edge of the belt is caused to bear against the stop bar and to undergo the linear and rotational motion from the one edge to an opposite edge of the belt.

3. The parts inspection system of claim 2 further comprising a guard rail positioned parallel to the stop bar and defining a gap therebetween through which the workpiece transits during the linear and rotational motion.

4. The parts inspection system of claim 2 further comprising the first plurality of light sources and the video camera positioned between the conveyor one edge and the opposite edge.

5. The parts inspection system of claim 2 further comprising an escapement positioned adjacent to the opposite edge controlled to provide a plurality of discharge paths of the workpieces including an accept path and a reject path as a function of their meeting predetermined criteria or not meeting the criteria.

6. The parts inspection system of claim 1 further comprising the first plurality of light sources including a first linear array formed by a plurality of discrete light emitting elements extending along the workpiece path spaced radially from the workpiece path and aligned with the workpiece path, and a second linear array formed by a plurality of discrete light emitting elements extending along the workpiece path spaced radially from the workpiece path and aligned with the workpiece path, the first and the second linear arrays oriented to present light directed to the workpieces at the different angular positions relative to the workpiece path.

7. The parts inspection system of claim 6 further comprising the first and second arrays each presenting a line of light oriented toward the workpiece, the lines of light creating separate generally straight lines observed by the camera as reflections from the workpiece for an ideal cylindrical workpiece, and wherein at least one of the observed lines on the workpieces is not a straight line or is not continuous in the presence of a defect illuminated by the lines of light.

8. The parts inspection system of claim 7 further comprising the first and second linear arrays carried by a semicircular shell enclosing the workpiece path.

9. The parts inspection system of claim 1 further comprising a second plurality of light sources oriented to illuminate the workpiece at an end of the workpiece and a second camera for observing light reflected by the workpiece emitted by the second plurality of light sources.

10. The parts inspection system of claim 9 further comprising the second plurality of light sources oriented in a circular array around an optical axis of the second camera.

11. The parts inspection system of claim 1 wherein the workpiece is in the form of an ammunition cartridge.

12. The parts inspection system of claim 1 further comprising wherein the first plurality of light sources is formed by individual LED elements.

13. The parts inspection system of claim 1 further comprising wherein the optical axis of the camera is aligned on a radial plane of the workpiece path.

14. The parts inspection system of claim 7 further comprising wherein the first and second linear arrays of light sources form an annular separation relative to the workpiece axis of about 20°.

15. A parts inspection of claim 1 further comprising means for capturing and processing images from the camera wherein when the workpiece enters the field of view of the camera, the workpiece remains within the field of view of the camera long enough to capture images of all sides of the workpiece, and filtering, correcting, and aggregating together the resulting image, and generating at least one statistical model of the workpiece.

16. A parts inspection of claim 15 wherein the means for capturing and processing images from the camera further comprises comparing an image of the workpiece to the at least one statistical model of the workpiece to classify the workpiece as meeting dimensional criteria or not meeting dimensional criteria.

17. A parts inspection system for a rotationally symmetrical elongated workpiece comprising,
a conveyor causing the workpiece to undergo linear motion and simultaneous rotational motion along a workpiece path, the conveyor in the form of an endless belt moving along a conveyor path and a stop bar oriented above the conveyor belt and oriented at an angle to the conveyor path whereby the workpiece introduced at near one edge of the belt is caused to bear against the stop bar and undergo the linear and rotational motion from the one edge to an opposite edge of the belt,
a first plurality of light sources presenting sources of light illuminating the workpiece at a plurality of discrete radial orientations with respect to the central axis of the workpiece path as the workpiece undergoes the linear and rotational motion, the first plurality of light sources including a first linear array formed by a plurality of discrete light emitting elements oriented to extend along the workpiece path spaced radially from the workpiece path and aligned with the workpiece path, and a second linear array formed by a plurality of discrete light emitting elements extending along the workpiece path spaced radially from the workpiece path and aligned with the workpiece path, the first and the second linear arrays oriented to present light directed to the workpiece at the different angular positions relative to the workpiece path,
a video camera oriented to detect an image of the reflections of light from the first and second linear arrays of light sources from the workpiece,
the first and second linear arrays each presenting a line of light oriented toward the workpieces, the lines of light creating separate generally straight lines observed by the camera as reflections from the workpiece for an ideal workpiece, and wherein at least one of the observed lines on the workpieces is not a straight line or is not continuous in the presence of a defect illuminated by the first and second linear arrays, and
an escapement positioned adjacent to the opposite edge controlled to provide a plurality of discharge paths of the workpieces including an accept path and a reject path as a function of their meeting predetermined criteria or not meeting the criteria.

18. The parts inspection system of claim 17 further comprising a guard rail positioned parallel to the stop bar and defining a gap therebetween through which the workpiece transits during the linear and rotational motion.

19. The parts inspection system of claim 17 further comprising the first and second linear arrays carried by a semicircular shell enclosing the workpiece path.

20. The parts inspection system of claim 17 further comprising a second plurality of light sources oriented to illuminate the workpiece at an end of the workpiece and a second camera for observing light reflected by the workpiece emitted by the second plurality of light sources.

21. The parts inspection system of claim 17 further comprising the second plurality of light sources oriented in a circular array around and optical axis of the second camera.

22. The parts inspection of claim 17 wherein the workpiece is in the form of an ammunition cartridge.

23. The parts inspection system of claim 17 further comprising wherein the first plurality of light sources is formed by individual LED elements.

24. The parts inspection system of claim 17 further comprising wherein the optical axis of the camera is aligned on a radial plane of the workpiece path.

25. The parts inspection system of claim 17 further comprising wherein the first and second arrays of light sources form an annular separation relative to the workpiece axis of about 20°.

26. A parts inspection of claim 17 further comprising means for capturing and processing images from the camera wherein when the workpiece enters the field of view of the camera, the workpiece remains within the field of view of the camera long enough to capture images of all sides of the workpiece, and filtering, correcting, and aggregating together the resulting image, and generating at least one statistical model of the workpiece.

27. A parts inspection of claim 17 wherein the means for capturing and processing images from the camera further comprises comparing an image of the workpiece to the at least one statistical model of the workpiece to classify the workpiece as meeting dimensional criteria or not meeting dimensional criteria.
